(19) United States
(12) Patent Application Publication
(10) Pub. No.: US 2015/0115593 A1
(43) Pub. Date: Apr. 30, 2015

(54) Instant game ticket with multiline slot machine or wheel theme

(71) Applicant: Kathleen Nylund Jackson, Scituate, MA (US)

(72) Inventor: Kathleen Nylund Jackson, Scituate, MA (US)

(73) Assignee: Precedent Gaming, Inc., Scituate, MA (US)

(21) Appl. No.: 14/121,661

(22) Filed: Oct. 3, 2014

Related U.S. Application Data
(60) Provisional application No. 61/961,267, filed on Oct. 9, 2013.

(51) Int. Cl. A63F 3/06; B41M 3/00

(52) U.S. Cl. CPC A63F 3/06; B41M 3/005
USPC 283/67

(57) ABSTRACT

A method of playing a lottery instant scratch game ticket. Each ticket provides a printed grid resembling a multiline slot machine game, comprised of symbol boxes arranged in columns and rows. Each symbol box contains one of a predetermined amount of game symbols and is covered by an indicia-labeled opaque removable film. Also provided are player indicia covered by an unlabeled opaque removable film. After scratching off the opaque film covering the player indicia, the revealed player indicia are compared to the indicia on the symbol boxes. The player scratches off the opaque film covering each symbol box that has an indicium that matches a player indicium, thereby revealing game symbols. The game symbols are then compared to official winning paylines and a prize legend to determine any wins.

### RELATED APPLICATION DATA

This application claims priority from U.S. Provisional Patent Application Ser. No. 61/961,267, filed Oct. 9, 2013, and having the Title INSTANT GAME TICKET WITH SLOT MACHINE OR WHEEL THEME.

### BACKGROUND OF THE INVENTION

1. Field of the Invention

The present invention relates to an instant game ticket (otherwise known in the art as a “scratch ticket”). The invention further relates to lottery gaming wherein a physical instant game ticket may be purchased and verified at a lottery agent location or other suitable locations, the ticket utilizing a gameplay that provides prizes based on a simulated result of a multiline slot machine. In a separate embodiment, the instant scratch ticket may be electronic and displayed on a monitor screen.

2. Background of the Art

For nearly 50 years, scratch tickets have been offered for sale as part of state and national lotteries. These tickets typically have an array of winning numbers and an array of player numbers, each concealed by a removable film. The player scratches off the film to reveal the numbers. If a winning number matches a player number, a prize is won. A major drawback lies in the simplicity of the typical game—scratching and matching numbers can get boring and tedious. Another drawback is that these simple games are very quick, hence the term “instant ticket”.

Scratch ticket games are provided wherein a predetermined number of tickets are printed, each ticket providing either a losing result or a winning result. The amount of tickets with losing results is predetermined, as are the number of tickets with winning results. Also predetermined is the number of tickets for each individual win amount. The total amount of awards of the winning tickets will be less than the total cost of all tickets in the game. For instance, a total of 90,720,000 $5 tickets may be printed and sold. The total ticket sales will be $453,600,000. The total payout to players may be $345,471,000.

Since the revenues from scratch ticket sales benefit cities, towns and schools, states in particular have a vested interest in providing new and exciting games that will keep the players buying the tickets and playing the games. Casino game-based themes such as blackjack and poker have proven to be popular. It is estimated that about 33% of American adults frequent casinos, and 75% of those play slot machines most often. By far the most popular machines are multiline video slots, displaying an array of fifteen or more symbols and providing multiple paylines. Players enjoy these games because they offer multiple ways to win, increasing the anticipation and excitement.

Various attempts have been made to create new instant games with familiar casino gameplay that may take longer to play in order to increase player participation and enjoyment.

Prior art teaches several lottery ticket concepts that provide a slot machine-like game theme. U.S. Pat. No. 8,231,449 (Martineck, Sr.) describes an instant-win lottery ticket in which symbols are connected by lines in order to win a prize. U.S. Pat. No. 8,221,208 (Hill, et al.) discloses a method and system for playing a terminal based lottery game having a slot machine theme includes assigning a defined set of objects to respective slot positions, the objects being unknown to game players. A player chooses at least one grouping of the slot positions from a plurality of possible groupings, and the system records the player's selection. For each of the slot positions, the system randomly selects an object from the set of objects assigned to each respective slot position such that a play set of the objects is generated for the player's grouping of slot positions. The player is awarded a prize amount that is a function of the number or combination of matches of objects within the player's play set. U.S. Pat. No. 7,980,559 (Miller, et al.) discloses a lottery ticket having a play area containing rows and columns defining individual play spaces with up to all of the play spaces containing a play symbol and at least one line connecting a plurality of play spaces wherein a prize may be won if the line connects at least two preselected play symbols. U.S. Application No. 20140123464 (Martineck, Sr.) discloses a lottery scratch ticket game comprising two sets of indicia and wherein the indicia in both sets are identical or have equal point values. U.S. Application No. 20060197283 (Thinnes) describes a lottery-type gaming system simulating a traditional casino game, such as slot machines. The gaming system includes a plurality of player cards or tickets and one or more master game cards. Each of the player cards or tickets includes at least one player game symbol indicative of a game symbol in the conventional casino game. At least one of the master game cards includes at least one community game symbol indicative of a game symbol in the conventional casino game.

In addition, the North Carolina Education Lottery has offered two different scratch tickets (“Super Slots” and “Super LOTERIA”) that have a slot machine-like theme featuring two games of four spin lines each. In “Super Slots”, players win by matching three like symbols in any spin across. If a player wins on four straight spins in a single game, they can scratch off the bonus area to reveal an additional prize. In “Super LOTERIA”, a 4×4 grid of 16 game symbols provides 10 paylines, and the player must match all four symbols in a payline in order to win.

Other prior art teaches poker or card-based instant games. U.S. Pat. No. 7,481,432 (Feola) describes a method of playing a Texas Hold'Em poker-type scratch ticket game comprising two-card starter hands and five community cards. U.S. Pat. No. 7,429,044 (O'Brien) also teaches a scratch ticket game card simulating an instant Texas Hold'Em Poker game card with a plurality of sets of player hands and a set of opponent hands, a set of community cards, and at least two prizes. U.S. Pat. No. 7,410,168 (Gumina) discloses a lottery instant win game card simulating a Hold'Em Poker styled card game with multiple chances of winning for a player. The instant game card includes at least two sets of player hands and at least two sets of opponent hands, with at least two sets of community cards, and at least two prizes.

Prior art also reveals several concepts that utilize a word theme on an instant lottery ticket. U.S. Pat. No. 7,497,778 (Bozeman) teaches a word-based lottery game wherein a player buys a ticket with a word or set of words and may win a prize if the outcome of a draw confers a win status to one or more words in the ticket. U.S. Pat. No. 6,241,246 (Guttin, et al.) discloses a lottery ticket having a first game area with a grid of target letters arranged so that at least some of the letters form target words and a second game area having a list of preselected game words that are covered by a scratch-off layer. The game words are matched with the target words to determine if a prize has been won.

Still further prior art teaches Sudoku-based game tickets. U.S. Pat. No. 7,431,295 (Scymgeour, et al.) discloses a lottery ticket that has printed thereon a matrix of nine rows and nine columns defining eighty one locations some of which are pre-marked with numbers from 1 to 9 and is arranged such that the player can select and enter the numbers in open locations to provide an arrangement of the numbers in which the marked locations and the open locations contain a number selected from the numbers 1 to 9 where all columns and all rows have the nine locations thereof each containing one of the numbers 1 to 9 with each number appearing once only. Prizes are awarded depending on the appearance of at least one of the numbers in at least one of the locations or depending on the total number of correct rows or columns or other matrix shape of nine locations. U.S. Pat. No. 7,458,580 (Martineck) describes a lottery instant game ticket including a plurality of squares distributed in a matrix format, and a plurality of game indicia initially covered by a removable material. Each squares of the matrix are populated with a game symbol and some of the squares of the matrix are covered by the removable material, forming a Sudoku puzzle. A player may play the Sudoku puzzle using the matrix. The player may remove the removable material from the game indicia and covered squares. If the squares identified by the game indicia form a predefined pattern, a prize is awarded to the player. U.S. Application No. 20070187888 (Dures, et al.) discloses a lottery game card for playing a Sudoku-themed game. The lottery game card includes a plurality of squares arranged in rows and columns, each square having a symbol. Selected squares are covered with a removable material. The lottery game card also includes a plurality of prize indicators, each prize indicator being associated with a predefined pattern of squares. Upon removing of covered squares by a player, if symbols in the plurality of squares match a predefined pattern, the player wins a prize associated with the predefined pattern.

Each of the references discussed in this text art are incorporated herein in their entirety for all purposes.

It is an ever-increasing challenge to provide players with new and enticing gameplay features that will stimulate player interest and increase participation in instant lottery games. It is an objective of the present invention to remedy the scratch-time and boredom problems of the typical scratch ticket by providing a familiar multiline slot game or wheel theme that increases anticipation throughout the gameplay.

### SUMMARY OF THE INVENTION

The present invention discloses a method of playing a lottery instant scratch ticket game comprised of a plurality of physical tickets, wherein each ticket provides two printed grids. The first grid is comprised of symbol areas in a geometric arrangement that each has a game symbol printed within and each symbol area is covered by an opaque removable film labeled by one of a predetermined set of non-repeating indicia. The second grid is comprised of player indicia from the set of non-repeating indicia and covered by an unlabeled opaque removable film. An array of predetermined official winning paylines is provided, each payline consisting of at least three symbol areas that are preferably adjoined adjacently. Prizes are awarded for at least two adjacent like game symbols on an official winning payline. Play instructions are also printed on the ticket, as well as a prize legend. Upon purchase of the instant scratch ticket, the player is prompted according to the play instructions to first remove or “scratch off” the opaque film covering the player indicia to reveal the player indicia. The player is then prompted to remove or “scratch off” the labeled opaque film covering each symbol box that matches a player indicium to reveal a game symbol. After all of the matching symbol boxes have been scratched, the revealed game symbols are compared to each predetermined winning payline and the prize legend in order to determine any prizes won.

### BRIEF DESCRIPTION OF THE FIGURES

FIG. 1 shows the first embodiment of an instant scratch ticket containing the game elements for a game utilizing the game technology described herein.

FIG. 2 shows the elements of FIG. 1, with the first three player numbers being revealed by scratching off the opaque film covering each player number box. Symbol boxes in the slot machine game matching the revealed player numbers are then scratched, revealing game symbols.

FIG. 3 shows the elements of FIG. 2, with all the player numbers being revealed, and with the matching symbol boxes being scratched, revealing the final array of game symbols.

FIG. 4 shows the elements of FIG. 3, with the final win amount being verified.

FIG. 5 shows a second embodiment of an instant scratch ticket containing the game elements for a game utilizing the game technology described herein.

FIG. 6 shows the elements of FIG. 5 at a final stage.

### DETAILED DESCRIPTION OF THE INVENTION

The present invention discloses a lottery game in which a plurality of instant scratch tickets is provided. The present invention describes the physical lottery instant scratch ticket, and the method of play thereof. A wager of cash, credits or non-monetary points may be required to play the game. The denomination and name of the game are preferably shown on the ticket, as well as play instructions. Also, a printed security code may be provided and concealed by an opaque film. The said security code provides an encryption that guarantees that the ticket is valid and maintains the authenticity of the instant game ticket.

The ticket provides a printed game grid comprised of at least nine symbol areas or “boxes”, preferably arranged in at least a 3-column×3-row configuration. It should be appreciated that game grids with a greater amount of symbol boxes are also preferably arranged in a column×row configuration, for example 4×3, 4×4, 5×3, 5×4, 5×5, etc. In a separate embodiment, other configurations such as a circular (or hexagonal, octagonal, etc.) grid may be utilized, comprised of preferably at least eight wedge- or pie-shaped symbol boxes. In other words, the circular grid is a wheel, divided into at least eight segments, each segment radiating out from the center. In both the column×row configuration, and the circular configuration, each symbol box is covered by a labeled opaque removable film, with a game symbol being concealed within each symbol box. Each symbol box label consists of a unique indicium, preferably a number or a letter, from a predetermined set of indicia. For the sake of clarity, this detailed explanation of the present invention will utilize individual unique numbers as the preferred indicia, although letters or other simple symbols (stars, circles, squares and the like) may be used. The total amount of unique numbers equals the total amount of symbol boxes. The number labels may be in ordinal fashion (for example, in a 5×3 grid, the top row of five symbol boxes may be labeled 1, 2, 3, 4, 5 from left to right, the middle row of five symbol boxes may be labeled 6, 7, 8, 9, 10 from left to right, and the bottom row of five symbol boxes may be labeled 11, 12, 13, 14, 15 from left to right) or in a non-ordinal fashion (for example, in a circular grid, eight pie-shaped sections [each section is a symbol box] may be labeled 6, 2, 1, 8, 5, 3, 4, 7 adjacently).

A printed grid comprised of player number (or letter or indicium) boxes that are covered by an unlabeled opaque removable film is also provided. The amount of player number boxes at most equals the amount of symbol boxes. Each of the concealed player numbers within each player number box match one of the numbers labeling one of the symbol boxes. Each player number box may either contain a single unique number, a special symbol such as a multiplier or “scratch all” icon, or be blank. In an alternate version, the player numbers may be printed within a single player number box and concealed by an unlabeled opaque removable film. Each of the player numbers within the single player number box matches one of the symbol box number labels, with the player number box containing at least three different numbers and up to and including all of the numbers labeling the symbol boxes. Special symbols as described above may also be included in the player number set.

An array of various predetermined winning paylines is preferably illustrated or explained on the ticket. In the case of a column×row arrangement, any arrangement of symbol boxes may be utilized although, preferably, each payline consists of one symbol box in each of the columns in the game grid. For instance, in a 5×5 grid, one symbol box in the first column, one symbol box in the second column, one symbol box in the third column, one symbol box in the fourth column and one symbol box in the fifth column define a payline. Preferably, all symbol boxes in each winning payline are adjoined horizontally or diagonally from left to right (although right to left readings may be used depending on the rules of the game), and each payline preferably begins with a symbol box in the first column and ends with a symbol box in the last column. At least one symbol box appears in at least three different paylines. Prizes may be awarded for at least two, but preferably at least three, adjoining like game symbols (from left to right, beginning with the first column) on a winning payline. In the case of a circular grid, at least three adjacent symbol boxes define a payline and prizes may be awarded for at least two, but preferably at least three, adjacent like game symbols in a payline. At least one symbol box appears in at least three paylines. A scatter pay feature may also be provided for the column×row grid and/or the circular grid, in which at least two predetermined scatter pay game symbols may appear anywhere in the grid regardless of appearing in a predetermined payline or being adjacent in order to win a prize.

A prize legend is also provided. The prize legend describes various winning game symbol combinations from a predetermined game symbol set. Each game symbol (numbers, letters, geometric designs, specific icons [trees, animals, birds, people, etc.] etc.) has its own paytable. For instance, XXX may pay $5, XXXX may pay $10 and XXXXX may pay $25. YYY may pay $10, YYYY may pay $50 and YYYYY may pay $5000. ZZZ may pay $100, ZZZZ may pay $10,000 and ZZZZZ may pay the jackpot ($500,000, for instance).

The instant ticket of the present invention may also include special graphics (starbursts, for example) that may convey to the player the jackpot amount or the number of ways to win. A separate area concealed by an opaque removable film may also be provided; when scratched, it may reveal a verification code defining and verifying the worth of the ticket. For instance, the letters T-E-N may prove a ten-dollar win result; the letters T-W-Y may prove a twenty-dollar win result; the letters O-X-Z may prove a non-winning or losing result.

Upon purchase of the instant scratch ticket, the player is prompted according to the play instructions to first remove or “scratch off” the opaque film covering all of the player numbers, revealing at least some of the individual numbers from the set of numbers that label the symbol boxes. The player is then prompted to remove or “scratch off” the labeled (numbered) opaque film covering each symbol box that matches a player number. Each revealed symbol box contains a game symbol from the predetermined game symbol set. It should be appreciated that special symbols such as wild symbols may be added to the predetermined game symbol set, and may act to replace any symbol other than scatter pay symbols. After all of the matched symbol boxes have been scratched, the revealed game symbols are compared to each predetermined winning payline and the prize legend in order to determine any prizes won.

In order to verify any winning amount, the verification code is revealed by scratching off the overlaying opaque film. Any winning ticket (according to the verification code) is then reverified by a security code by processing the ticket through a computer terminal comprised of at least a computer processor at a lottery agent location or other suitable locations. The security code is revealed and processed at this time to ensure the authenticity of the ticket.

In a first exemplary preferred embodiment, a scratch ticket is provided, having a particular theme that provides familiarity and engages the player. In this example, a $5 ticket is entitled “Holiday Slot Fest”. The predetermined game symbol set consists of a holiday tree, a snowman, a candle, a dreidel, and a present, with a special snowflake symbol being the scatter pay symbol. A prize legend is provided that explains the payoffs for individual game symbol combinations (left to right on an official predetermined payline) and the scatter pay payoffs. Scatter pay symbols may appear anywhere in the grid, and need not be positioned on an official payline. In this embodiment, three holiday trees would pay $5, four holiday trees would pay $10, and five holiday trees would pay $25; three snowmen would pay $5, four snowmen would pay $10, and five snowmen would pay $50; three candles would pay $5, four candles would pay $25, and five candles would pay $100; three dreidels would pay $10, four dreidels would pay $50, and five dreidels would pay $500; three presents would pay $25, four presents would pay $100, and five presents would pay $5000; three scatter pay snowflakes would pay $5, four scatter pay snowflakes would pay $10, and five scatter pay snowflakes would pay the jackpot of $500,000. It may be possible to achieve multiple wins on one ticket, although in the case of one particular game symbol (a candle, for instance), only the highest amount of that game symbol on an official payline would win. It should be appreciated that all payoffs are exemplary only, and are subject to change according to the rules of the game and the math model utilized.

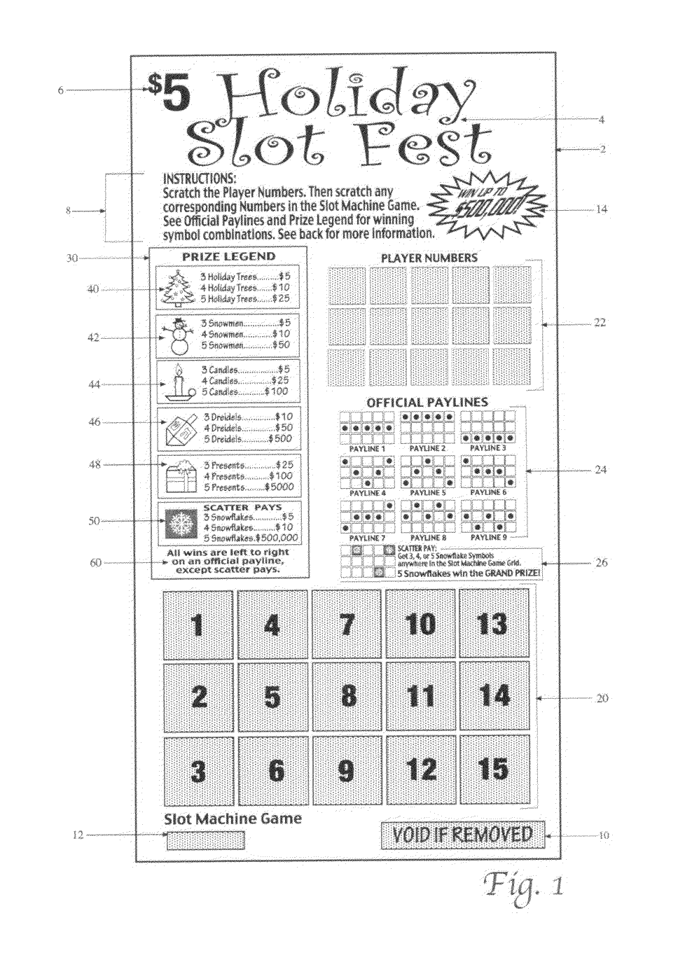

A graphic interpretation of the official paylines is also provided. In this preferred exemplary embodiment of the present invention, each of nine winning paylines are graphically displayed, with solid circles indicating game symbols within the position of the symbol boxes in the slot machine game grid. It should be appreciated that any other configuration of paylines as well as the amount of paylines may be used as dictated by the design, rules and the math model underlining the present invention. Scatter pay win rules are also provided (see FIG. 1).

Also provided are fifteen symbol boxes in a 5-column×3-row arrangement, each symbol box covered by a labeled opaque removable film. Each symbol box is labeled with a different number from 1 to 15 inclusive. The first column consists of three symbol boxes that are individually numbered 1 through 3 from top to bottom. The second column consists of three symbol boxes that are individually numbered 4 through 6 from top to bottom. The third column consists of three symbol boxes that are individually numbered 7 through 9 from top to bottom. The fourth column consists of three symbol boxes that are individually numbered 10 through 12 from top to bottom. The fifth column consists of three symbol boxes that are individually numbered 13 through 15 from top to bottom.

There are also fifteen player number boxes, each covered by an unlabeled opaque film that conceals one unrepeated number from the number set 1 through 15 inclusive, a special symbol such as a multiplier symbol or a “scratch all” symbol, or a blank space. By following the printed instructions on the ticket, the player is prompted to remove or “scratch off” the opaque film concealing the player numbers, herein revealing either a number or a blank. The player numbers are then compared to the numbered symbol boxes. The player “scratches off” the numbered opaque film covering each symbol box that matches a player number, each scratched symbol box revealing one game symbol from the predetermined set of game symbols. (If a wild symbol is included in the game symbol set, the wild symbol may act to replace any other game symbol except for the scatter pay symbol. If a multiplier is included in the game symbol set, the multiplier may act to replace any other game symbol in a winning symbol combination while multiplying the amount won. For example, snowman, snowman, 3×, snowman, snowman would pay $50×3, or $150. If a “scratch all” symbol is included in the game symbol set, all of the numbered symbol boxes would be scratched off.) After all of the matched symbol boxes have been scratched, the revealed game symbols are compared to each predetermined winning payline and the prize legend in order to determine any prizes won.

In order to verify any winning amount, the verification code is revealed by scratching off the overlaying opaque film. Any winning ticket (according to the verification code) is then reverified by a security code by processing the ticket through a computer terminal comprised of at least a computer processor at a lottery agent location or other suitable locations. The security code is revealed and processed at this time to ensure the authenticity of the ticket.

In a second exemplary preferred embodiment, a $5 scratch ticket is provided, having a holiday theme. In this example, the ticket is entitled “Around the Holidays”. The predetermined game symbol set consists of a holiday tree, a snowman, a candle, a dreidel, and a present, with a special snowflake symbol being the scatter pay symbol. A prize legend is provided that explains the payoffs for individual symbol combinations (like symbols must be displayed adjacent to each other within a circular grid comprising wedge- or pie-shaped symbol boxes) and the scatter pay payoffs. Scatter pay symbols may appear anywhere in the grid, and need not be positioned adjacently. In this embodiment, three holiday trees in a row (displayed adjacently) would pay $5, four holiday trees (displayed adjacently) would pay $10, and five holiday trees (displayed adjacently) would pay $25; three snowmen (displayed adjacently) would pay $5, four snowmen (displayed adjacently) would pay $10, and five snowmen (displayed adjacently) would pay $50; three candles (displayed adjacently) would pay $5, four candles (displayed adjacently) would pay $25, and five candles (displayed adjacently) would pay $100; three dreidels (displayed adjacently) would pay $10, four dreidels (displayed adjacently) would pay $50, and five dreidels (displayed adjacently) would pay $500; three presents (displayed adjacently) would pay $25, four presents (displayed adjacently) would pay $100, and five presents (displayed adjacently) would pay $5000; three scatter pay snowflakes would pay $5, four scatter pay snowflakes would pay $10, and five scatter pay snowflakes would pay the jackpot of $500,000. It may be possible to achieve multiple wins on one ticket, although in the case of any one particular symbol (a candle, for instance), only the highest amount of those adjacent symbols would win. It should be appreciated that all payoffs are exemplary only, and are subject to change according to the rules of the game and the math model utilized.

Information is provided to explain the gameplay. Also provided are sixteen symbol boxes in a circular arrangement, each wedge-shaped symbol box covered by a labeled opaque removable film. Each symbol box is labeled with a different number from 1 to 16 inclusively. Paylines comprise each group of at least three adjacent symbol boxes up to a predetermined maximum amount of symbol boxes and at least one symbol box is contained in at least three different paylines. In this exemplary embodiment, any three, four or five adjacent symbol boxes are paylines.

There is a player number box, covered by an unlabeled opaque film that conceals at least three of the numbers and up to and including all numbers from the number set 1 through 16 inclusively. By following the printed instructions on the ticket, the player is prompted to remove or “scratch off” the opaque film concealing the player numbers. The player numbers are then compared to the numbered symbol boxes. The player “scratches off” the labeled opaque film covering each symbol box that matches a player number, each scratched symbol box revealing one of the game symbols. (If a wild symbol is included in the game symbol set, the wild symbol may act to replace any other game symbol except for the scatter pay symbol. If a multiplier is included in the game symbol set, the multiplier may act to replace any other game symbol in a winning symbol combination while multiplying the amount won. For example, snowman, snowman, 3×, snowman, snowman would pay $50×3, or $150. If a “scratch all” symbol is included in the game symbol set, all of the numbered symbol boxes would be scratched off.) After all of the matched symbol boxes have been scratched, the revealed game symbols are compared to the prize legend in order to determine any prizes won.

In order to verify any winning amount, the verification code is revealed by scratching off the overlaying opaque film. Any winning ticket (according to the verification code) is then reverified by a security code by processing the ticket through a computer terminal comprised of at least a computer processor at a lottery agent location or other suitable locations. The security code is revealed and processed at this time to ensure the authenticity of the ticket.

Reference to the Figures will assist in further understanding of the practice of the present invention.

FIG. 1 illustrates the first preferred embodiment of the present invention, providing the elements of present invention that afford the specific gameplay thereof. A physical lottery instant game ticket 2 is provided, comprising a game ticket name 4, the denomination of the ticket 6, a printed instruction area 8, a boxed area 10 covered with an opaque removable film (as illustrated by a grey dot pattern) providing a concealed security code, a boxed area 12 covered with an opaque removable film (grey dot pattern) providing a concealed verification code. A starburst symbol 14 announces the potential jackpot win amount. The Slot Machine Game is shown to have fifteen symbol boxes arranged in a 5×3 grid 20, with each symbol box being covered by an opaque removable film (grey dot pattern) and labeled with a single individual number from 1 to 15 inclusive. Nine official paylines (payline #1, payline #2, payline #3, payline #4, payline #5, payline #6, payline #7, payline #8, payline #9) 24 are graphically illustrated within nine grids (each grid representative of the Slot Machine Game grid). Each payline (illustrated by black circles representing slot symbols) begins with one game symbol in the first column, and ends with one game symbol in the fifth column. All game symbols in each official payline are horizontally or diagonally adjoined to adjacent game symbols. Also shown is a graphic representation of a scatter pay 26, with an explanation of how the scatter pay win is determined. A separate fifteen-box grid 22 provides player numbers that are concealed by an unlabeled opaque removable film (grey dot pattern). Also shown is a prize legend 30, comprising six different game symbols with prize information (five main game symbols [40, 42, 44, 46, 48] plus one scatter pay game symbol 50). Each explains the varying payoffs that are provided for three, four or five of like symbols. An informational legend 60 explains that all wins are left to right on an official payline, except scatter pays. (Scatter pays may be positioned anywhere in the grid, and need not be horizontally or diagonally connected.)

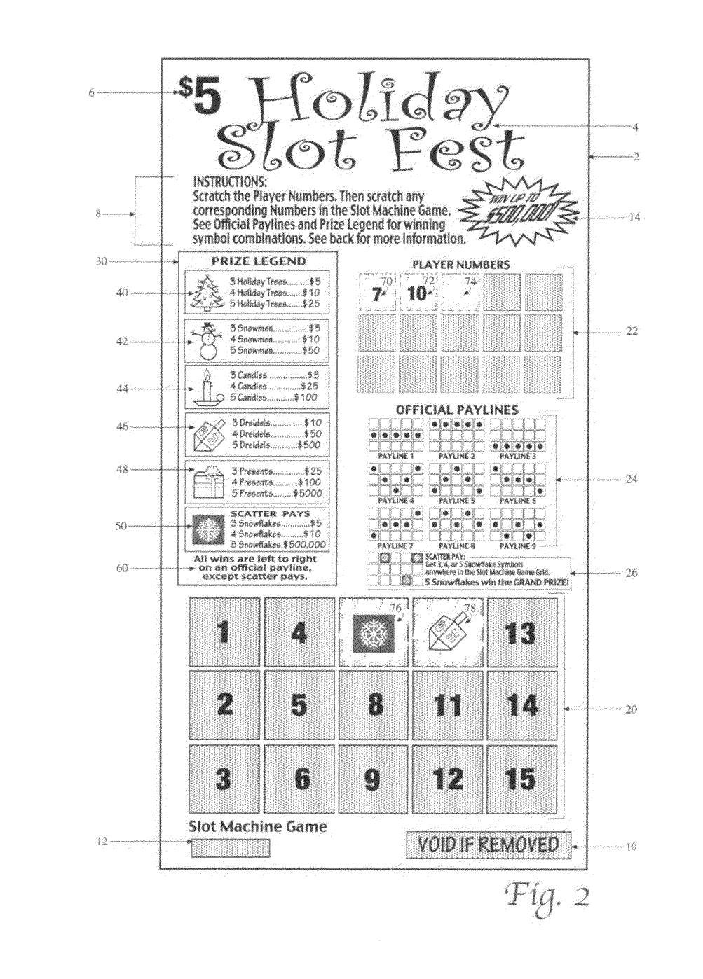

FIG. 2 shows the elements of FIG. 1 wherein the player has first removed or “scratched off” the unlabeled opaque film over the first three of the player number boxes in the top row, revealing a “7” 70, a “10” 72 and a blank box 74. The player then scratches off the matching numbers “7” and the “10” on the Slot Machine Game grid. Symbol box “7” reveals a scatter pay Snowflake 76, and symbol box “10” reveals a Dreidel 78. No symbol box is scratched for the blank player number.

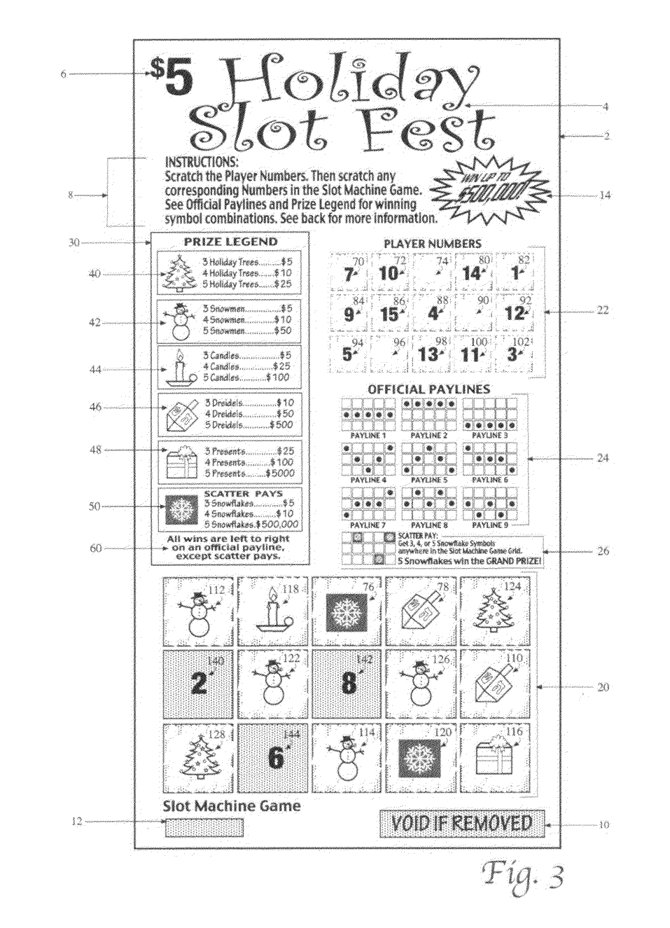

FIG. 3 shows the elements of FIG. 2 wherein, according to the gameplay instructions 8, the unlabeled opaque film covering the remainder of the player numbers have been scratched off, revealing a “14” 80, a “1” 82, a “9” 84, a “15” 86, a “4” 88, a blank box 90, a “12” 92, a “5” 94, another blank box 96, a “13” 98, an “11” 100, and a “3” 102. Then all remaining matching boxes in Slot Machine Game grid are scratched off to reveal the game symbols underneath, displaying the final Slot Machine Game result (from top to bottom, beginning with the first column: Snowman 112, unscratched slot symbol box “2” 140, Holiday Tree 128, Candle 118, Snowman 122, unscratched slot symbol box “6” 144, Snowflake 76, unscratched slot symbol box “8” 142, Snowman 114, Dreidel 78, Snowman 126, Snowflake 120, Holiday Tree 124, Dreidel 110, Present 116). After all of the matched symbol boxes have been scratched, the revealed game symbols are compared to each predetermined winning payline 24 and the prize legend 30 in order to determine any prizes won. In this example, there are four Snowmen (112, 122, 114, 126) along payline #4. According to the prize legend 30, and specifically the Snowman prize information 42, the four Snowmen are worth $10.

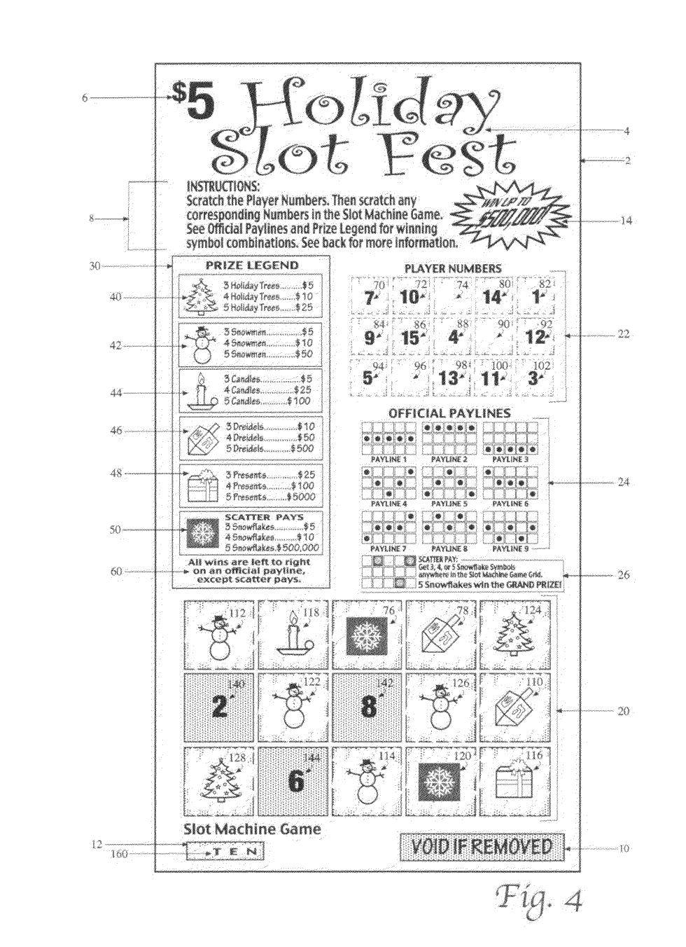

FIG. 4 shows the $10 win for getting four snowmen along payline #4 being verified by scratching off the opaque film over the verification code 12, revealing the verification code “T E N” 160, standing for “TEN DOLLARS”.

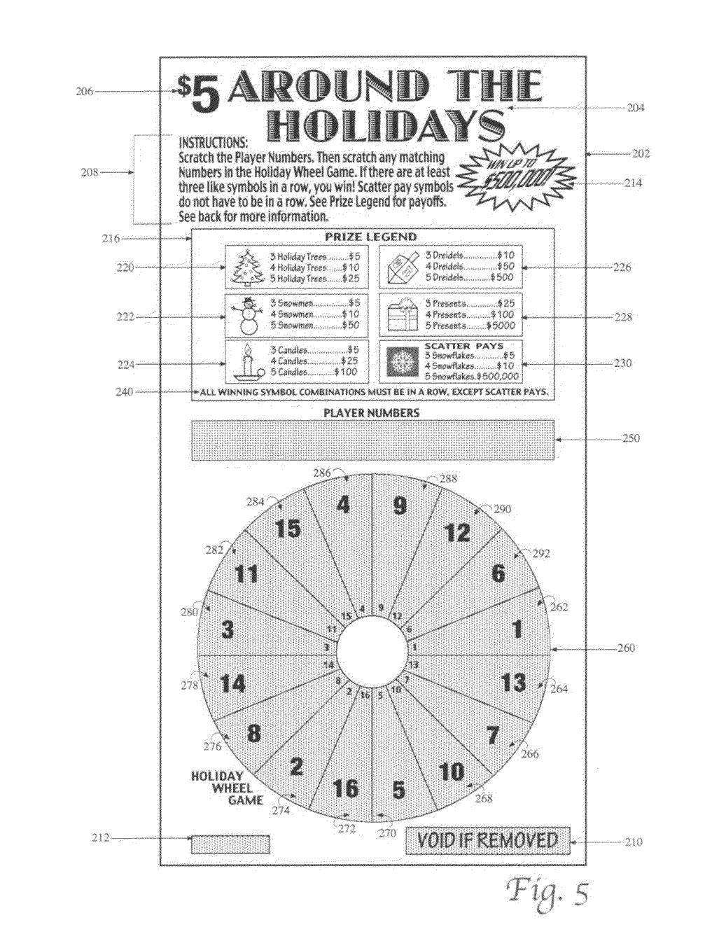

FIG. 5 illustrates the second preferred embodiment of the present invention. A physical lottery instant game ticket 202 is provided, comprising a game ticket name 204, the denomination of the ticket 206, a printed instruction area 208, a boxed area 210 covered with an opaque removable film (grey dot pattern) providing a concealed security code, a boxed area 212 covered with an opaque removable film (grey dot pattern) providing a concealed verification code. A starburst symbol 214 announces the potential jackpot win amount. A prize legend 216 is shown, comprising six different game symbols with prize information (five main game symbols [220, 222, 224, 226, 228] plus one scatter pay game symbol 230). Each explains the varying payoffs that are provided for three, four or five of like symbols. An informational legend 240 explains that all winning symbol combinations must be in a row (that is, the like symbols must be adjacent), except scatter pays. (Scatter pay symbols need not be adjacent.) The Holiday Wheel Game is shown to have sixteen symbol boxes (262, 264, 266, 268, 270, 272, 274, 276, 278, 280, 282, 284, 286, 288, 290, 292) arranged as sections in a circular grid 260, with each symbol box being covered by an opaque removable film (grey dot pattern) and labeled with a single individual number from 1 to 16 inclusive. A separate player number box 250 is concealed by an unlabeled opaque removable film (grey dot pattern).

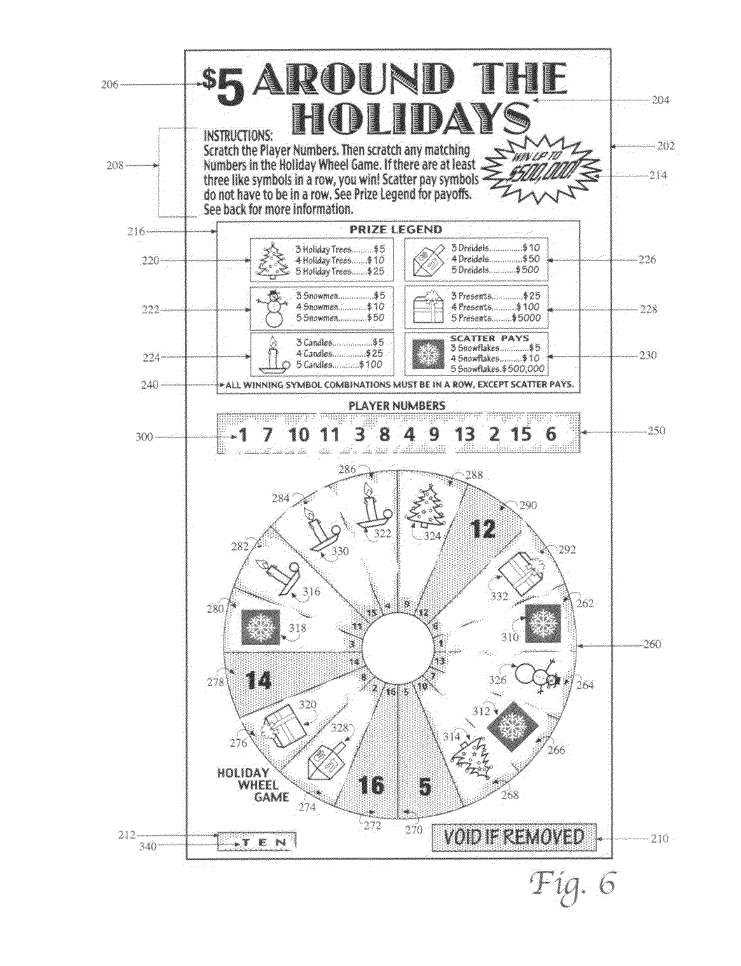

FIG. 6 shows the elements of FIG. 5 wherein, according to the gameplay instructions 208, the unlabeled opaque film covering the player numbers has been scratched off 300, revealing twelve different numbers (1, 7, 10, 11, 3, 8, 4, 9, 13, 2, 15, 6) from the sixteen number set 1 to 16 that labels the symbol boxes. It should be appreciated that a predetermined amount of player numbers may be afforded the player, or the amount of player numbers provided may be random or pseudo-random. The player then scratches off the symbol boxes that match the player numbers: symbol box 262 reveals a scatter pay Snowflake 310; symbol box 264 reveals a Snowman 326; symbol box 266 reveals a scatter pay Snowflake 312; symbol box 268 reveals a Holiday Tree 314; symbol box 270 is not scratched; symbol box 272 is not scratched; symbol box 274 reveals a Dreidel 328; symbol box 276 reveals a Present 320; symbol box 278 is not scratched; symbol box 280 reveals a scatter pay Snowflake 318; symbol box 282 reveals a Candle 316; symbol box 284 reveals a Candle 330; symbol box 286 reveals a Candle 322; symbol box 288 reveals a Holiday Tree 324; symbol box 290 is not scratched; and symbol box 292 reveals a Present 332. After all of the matched symbol boxes have been scratched, the revealed game symbols are compared to the prize legend 216 in order to determine any prizes won. In this example, there are three Candles in a row (316, 330, 322) and three scatter pay Snowflakes (310, 312, 318). According to the prize legend 216, three Candles are worth $5, and three Snowflakes are worth $5, for a total win of $10. The win is verified by scratching off the opaque film over the verification code 212, revealing the verification code “T E N” 340, standing for “TEN DOLLARS”.

It should be appreciated that the present invention may, as opposed to a physical ticket, provide an electronic ticket displayed on an electronic device that comprises at least a monitor screen, an electronic processor, and an input device. The said electronic ticket uses the same basic gameplay as described above in FIGS. 1 through 6 for the physical ticket, but wherein the player may “scratch off” any opaque layers by utilizing an input device such as a touchscreen, mouse, button or similar tool. Alternately, the “scratch off” process may be provided by the processor.

Although specific examples and specific win tables have been provided in this discussion, these specifics are intended to be only support for the generic concepts of the invention and are not intended to be absolute limits in the scope of the technology discussed.

What is claimed:

1. A method of conducting a lottery instant scratch ticket game comprising the steps of:
a) providing a plurality of physical scratch tickets;
b) providing a first printed grid on each ticket that comprises a predetermined amount of symbol areas;
c) providing within each symbol area a printed game symbol from a predetermined set of game symbols;
d) wherein each symbol area is covered by an opaque removable film, the removable film being labeled with a specific unique indicium from a predetermined set of indicia;
e) providing a second printed grid covered by an unlabeled opaque removable film that comprises at least a plurality of player indicia from the total amount of specific unique indicia labeling the symbol areas;
f) providing a predetermined amount of predetermined paylines, wherein each payline is comprised of a predetermined pattern of specific symbol areas and wherein at least one symbol area is contained in at least three different paylines;
g) providing a prize legend comprising a predetermined paytable for predetermined amounts of like game symbols on a predetermined payline;
h) removing the opaque film over the player indicia to reveal the player indicia;
i) removing the opaque film over any symbol area that is labeled with an indicium that matches a player indicium to reveal a game symbol;
j) analyzing the final revealed game symbols to determine if there are any wins according to the predetermined paylines and the prize legend;
k) determining if the value of the win(s) match a verification code; and
l) providing the value of the win(s) as an award.

2. The method of claim 1 wherein the value of the verified instant lottery ticket is then reverified using a security code by processing the ticket through a computer terminal comprised of at least a computer processor.

3. A method of conducting a game that provides an electronic ticket displayed on an electronic device that comprises at least a monitor screen, an electronic processor, and an input device, that comprises the steps of:
a) providing a first grid on the electronic ticket that comprises a predetermined amount of symbol areas;
b) providing within each symbol area a game symbol from a predetermined set of game symbols;
c) wherein each symbol area is covered by an opaque removable layer, the removable layer being labeled with a specific unique indicium from a predetermined set of indicia;
d) providing a second grid covered by an unlabeled opaque removable layer that comprises at least a plurality of player indicia from the total amount of specific unique indicia-labeling the symbol areas;
e) providing a predetermined amount of predetermined paylines, wherein each payline is comprised of a predetermined pattern of specific symbol areas and wherein at least one symbol area is contained in at least three different paylines;
f) providing a prize legend comprising a predetermined paytable for predetermined amounts of like game symbols on a predetermined payline;
g) removing the opaque layer over the player indicia to reveal the player indicia;
h) removing the opaque layer over any symbol area that is labeled with an indicium that matches a player indicium to reveal a game symbol;
i) analyzing the final revealed game symbols to determine if there are any wins according to the predetermined paylines and the prize legend; and
j) providing the value of the win(s) as an award.

4. The method of claim 3 wherein the player may remove any opaque layer by utilizing an input device such as a touchscreen, mouse, button or similar tool.

5. The method of claim 3 wherein the processor may function to remove any opaque layer without player input.
